(19) United States
(12) Patent Application Publication
(10) Pub. No.: US 2012/0066240 A1
(43) Pub. Date: Mar. 15, 2012

(54) FACILITY SEARCH DEVICE

(76) Inventors: Takuji Morimoto, Tokyo (JP); Takehisa Mizuguchi, Tokyo (JP); Reiko Okada, Tokyo (JP); Wataru Yamazaki, Tokyo (JP); Atsushi Matsumoto, Tokyo (JP)

(21) Appl. No.: 13/319,168

(22) PCT Filed: Jul. 31, 2009
(86) PCT No.: PCT/JP09/03651

§ 371 Date: Nov. 7, 2011

(51) Int. Cl. G06F 17/30

(52) U.S. Cl. 707/758; 707/E17.019; 707/E17.014

(57) ABSTRACT

A facility search device includes: a facility information storage unit that stores facility information; an additional information storage unit that stores additional facility information; a facility search unit that searches for facilities from the facility information and the additional facility information; a sameness determination unit that determines the sameness of facilities based on identifiers contained in the facility information on each of the facilities when the plurality of facilities are searched for by the facility search unit; a facility information synthesis unit that synthesizes the facility information on the facilities determined to be the same by the sameness determination unit among the searched facilities; a display image generation unit that generates images for displaying the searched facilities or the facilities synthesized by the facility information synthesis unit; and a display unit that displays the images generated by the display image generation unit.

### TECHNICAL FIELD

The present invention relates to a facility search device that is applied to a navigation system, for example, to make a search for facilities.

### BACKGROUND ART

In a car navigation system, there is a problem in that the facility information stored in the map database becomes obsolete with the passage of the date and time, and no longer coincides with the present circumstances. Meanwhile, there exists various types of information including facility information (also referred to as the “POI; Point Of Interest”) concerning facilities on the Internet, and such information can be easily acquired through a personal computer or the like. Under these circumstances, there are needs of users that would like to utilize the POI collected from the Internet by addition of the POI to the car navigation system.

Because a map database is often of a large capacity and has a complex structure, a great deal of time and cost are required for updating the map database. For this reason, it is not realistic to frequently update the map database using the POI (hereinafter referred to as the “additional POI”) acquired by the user from the Internet or the like.

As a simple method of updating the map database, the following method is specified, which includes the steps of: preparing an additional database for storing only the additional POI, in addition to the map database; simultaneously searching these map database and additional database upon making a search for facilities; and integrating and displaying the search results, to thus obtain the same effect as updating the map database.

Note that as a technology for displaying update information according to the update of a general map database, Patent Document 1 discloses a navigation system in which the updated information is easily conveyed to the user when old map information is updated. This navigation system includes: a map database that records map data on a fixed storage media; a map data reading unit that reads the map data from the map database; a navigation unit that detects the user's vehicle location and calculates the appropriate route to the destination designated by the user, and guides the user to the destination according to the route; a map information acquisition unit that acquires map information from the outside; and a map information update unit that updates the map database using the map information acquired by the map information acquisition unit, wherein the navigation unit highlights the data detected by the differential data detection unit.

Moreover, Patent Document 2 discloses a facility search device that enables the promotion of the effective utilization of information concerning new facilities by updating the map data. In this facility search device, the car navigation system causes the control unit and the HDD to at least change the facility information stored on the hard disk or add new facility information to the hard disk, causes the control unit to search for the facility information stored on the hard disk based on the information to be input during the facility search, and causes the control unit and the facility drawing list to display the additionally changed facility information on a display by differentiating it from the other facility information among the facility information obtained as the search result.

### PRIOR ART DOCUMENTS

### Patent Documents

Patent Document 1: Japanese Patent Application Laid-open No. 2002-188926

Patent Document 2: Japanese Patent Application Laid-open No. 2008-134308

Nevertheless, in the conventional simple method of updating the map database using an additional database described above, if the search result is simply displayed, there are cases where the POIs to be essentially the same can be displayed in an overlapping manner as separate POIs, which poses a problem such that the user is confused.

The present invention is made in order to resolve the foregoing problems, and an object of the invention is to provide a facility search device capable of displaying the POIs in a manner that can be easily understood by the user even when there are overlapping POIs.

### SUMMARY OF THE INVENTION

A facility search device of the invention includes: a facility information storage unit that stores facility information that is information relating to facilities; an additional information storage unit that stores additional facility information; a facility search unit that searches for facilities from the facility information stored in the facility information storage unit and the additional facility information stored in the additional information storage unit; a sameness determination unit that determines the sameness of facilities based on identifiers contained in the facility information on each of the facilities when the plurality of facilities are searched for by the facility search unit; a facility information synthesis unit that synthesizes the facility information on the facilities determined to be the same by the sameness determination unit among the facilities searched for by the facility search unit; a display image generation unit that generates images for displaying the facilities searched for by the facility search unit or the facilities synthesized by the facility information synthesis unit; and a display unit that displays the images generated by the display image generation unit.

According to the invention, in the case where both the facility information storage unit and the additional information storage unit are searched to display the facility information that is the search result, it is configured that the same facilities existing in the facility information storage unit and the additional information storage unit are synthesized and displayed based on the sameness determination, thereby prevent the facilities from being displayed in an overlapping manner.

### BRIEF DESCRIPTION OF THE DRAWINGS

FIG. 1 is a block diagram showing the configuration of the facility search device of Embodiment 1 in the present invention.

FIG. 2 is a diagram showing the configuration of the POI that is used in the facility search device of Embodiment 1 in the invention.

FIG. 3 is a diagram showing the configuration of the additional POI that is used in the facility search device of Embodiment 1 in the invention.

FIG. 4 is a diagram showing an example of a list that is obtained as the result of the facility search that is performed in the facility search device of Embodiment 1 in the invention.

FIG. 5 is a diagram showing the result that is obtained as a result of facility information synthesis that is performed in the facility search device of Embodiment 1 in the invention.

FIG. 6 is a diagram showing an example of the image that is generated by the facility search device of Embodiment 1 in the invention.

FIG. 7 is a flowchart showing the operation of the facility search device of Embodiment 1 in the invention mainly around the facility search processing.

FIG. 8 is a block diagram showing the configuration of the facility search device of a modified example of Embodiment 1 in the invention.

FIG. 9 is a diagram explaining the operation of the facility search device of Embodiment 2 in the invention.

FIG. 10 is a flowchart showing the operation of the facility search device of Embodiment 2 in the invention mainly around the facility search processing.

FIG. 11 is a block diagram showing the configuration of the facility search device of Embodiment 3 in the invention.

FIG. 12 is a block diagram showing the configuration of the facility search device of Embodiment 4 in the invention.

FIG. 13 is a block diagram showing the configuration of the facility search device of Embodiment 5 in the invention.

### BEST MODE FOR CARRYING OUT THE INVENTION

In the following, embodiments of the present invention will be described in detail with reference to the appended drawings.

### Embodiment 1

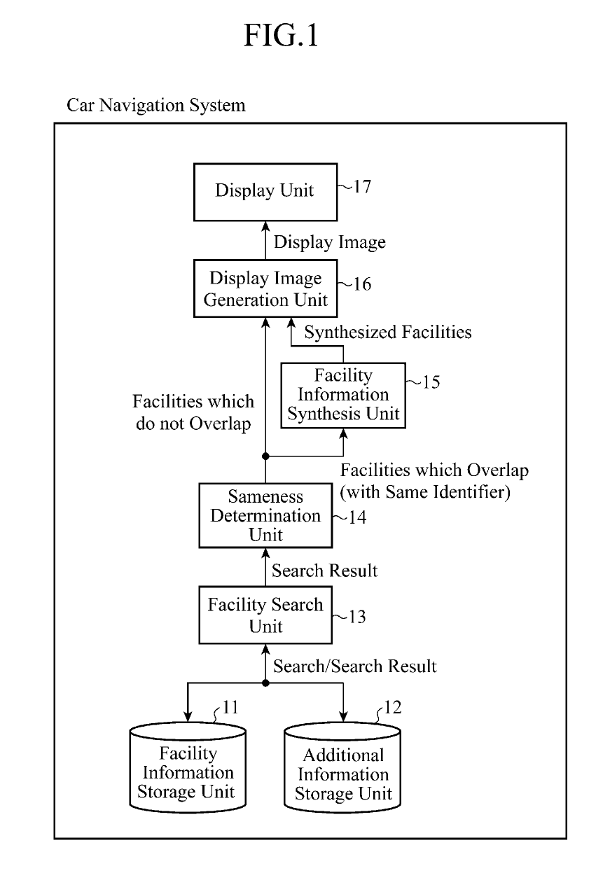

FIG. 1 is a block diagram showing the configuration of a facility search device of Embodiment 1 in the invention. Note that in the following explanation, the facility search device is explained as being realized in a car navigation system.

The facility search device of Embodiment 1 is composed of a facility information storage unit 11, an additional information storage unit 12, a facility search unit 13, a sameness determination unit 14, a facility information synthesis unit 15, a display image generation unit 16 and a display unit 17.

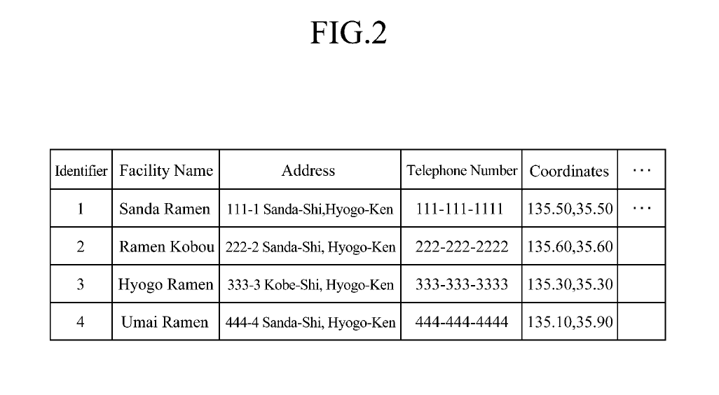

The facility information storage unit 11 stores a map database that is generally used in the car navigation system. The POIs contained in the map database include attribute information such as an identifier, a facility name, an address, a telephone number and coordinates as shown in FIG. 2. The facility information stored in the facility information storage unit 11 is referred to by the facility search unit 13.

The additional information storage unit 12 stores information (additional POI) acquired by the user from the outside of the vehicle such as the Internet. The additional POI stored in the additional information storage unit 12 can be configured to be periodically acquired from the outside of the vehicle, and also configured to be acquired from the outside of the vehicle as needed for the facility search (including instructions from the user).

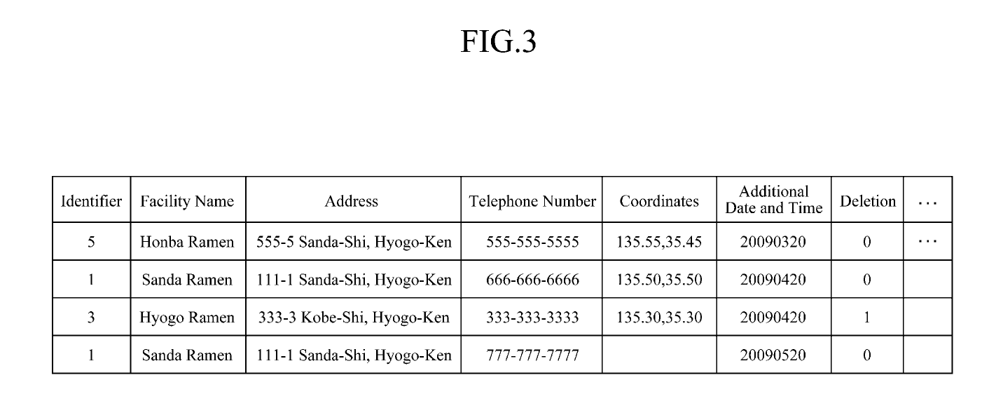

As shown in FIG. 3, the additional POI stored in the additional information storage unit 12 stores an additional date and time and a deletion flag, in addition to the attribution information included in the POI stored in the facility information storage unit 11. The POI in which the deletion flag is “1” means that the POI, which is the same as the POI existing in the additional information storage unit 12, has been deleted. Moreover, the deletion flag is also used for deleting the same POI existing in the facility information storage unit 11. Furthermore, the POI stored in the additional information storage unit 12 can also be configured to include extended attributes such as word-of-mouth information or facility usage fees that are not handled in the map database of conventional car navigation systems. Note that in FIG. 3, the existence of two POIs each having a facility name of Sanda Ramen means that an update is carried out (in the example, the telephone numbers are updated).

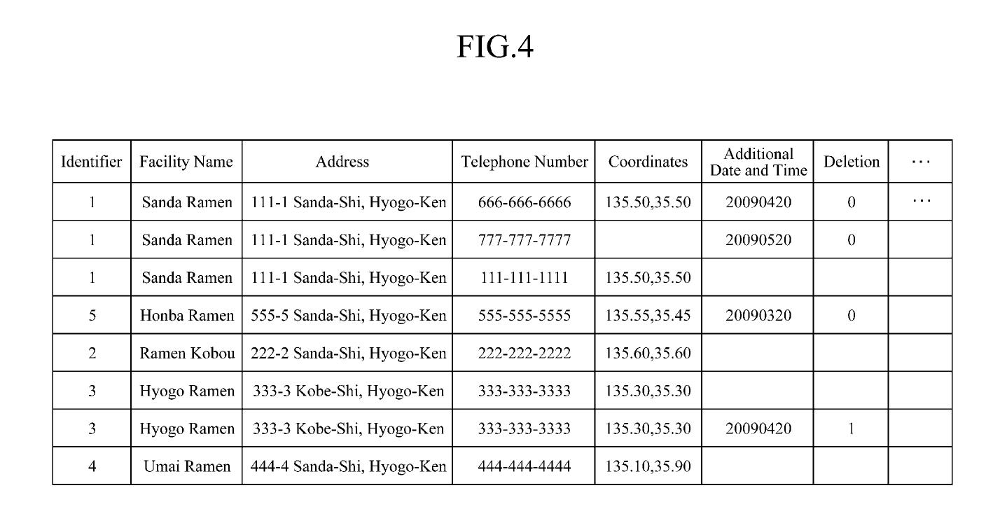

The facility search unit 13 searches for the POIs from both the facility information storage unit 11 and the additional information storage unit 12, and integrates the results obtained from the search. Hereinafter, the integrated search result is simply referred to as the “search result”. For example, if facilities around the present location (135.50, 35.50) are searched in a state where the facility information storage unit 11 stores the POIs shown in FIG. 2 and the additional information storage unit 12 stores the POIs shown in FIG. 3, the list shown in FIG. 4 is obtained as the search result. The POIs in FIG. 4 are listed in order of the distance from the present location; the POI shown in the higher row is closer to the present location. The search result obtained in the facility search unit 13 is sent to the sameness determination unit 14.

The sameness determination unit 14 determines the same POIs by using the identifiers based on the search result that is sent from the facility search unit 13. In the example shown in FIG. 4, three Sanda Ramens and two Hyogo Ramens are determined the same POIs, respectively. Consequently, if the search result shown in FIG. 4 is displayed as it stands, the same POIs are displayed in an overlapping manner; thus, there is a problem such that the user is confused. The determination result in the sameness determination unit 14 is sent to the facility information synthesis unit 15 and the display image generation unit 16.

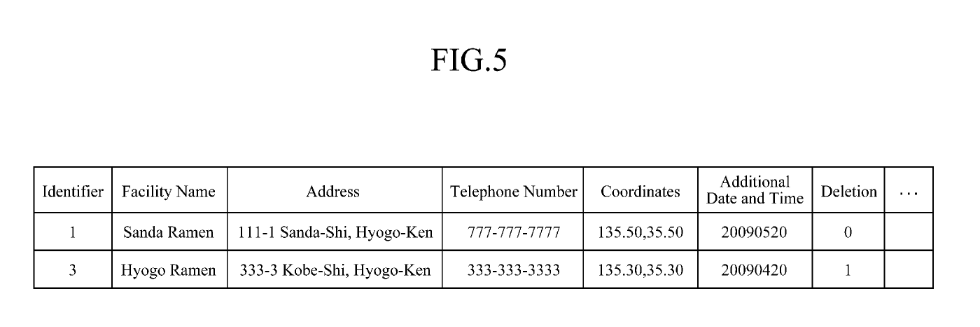

The facility information synthesis unit 15 synthesizes the plurality of POIs that are determined the same in the sameness determination unit 14 into a single POI. In this case, the facility information synthesis unit 15 refers to the additional date and time of the POIs and uses the newest attribute value as the attribute value of the synthesized POI. FIG. 5 shows the results of synthesizing the same POIs shown in FIG. 4. After the synthesis, in the POI in which the facility name is Sanda Ramen, the attribute value of the POI with the additional date and time “20090520” is used as the value of the facility name, address and telephone number. Moreover, since the POI with the additional date and time “20090520” is not provided with coordinate information, the coordinate information on the POI with the second newest additional date and time “20090420” is used as the attribute value of the synthesized POI.

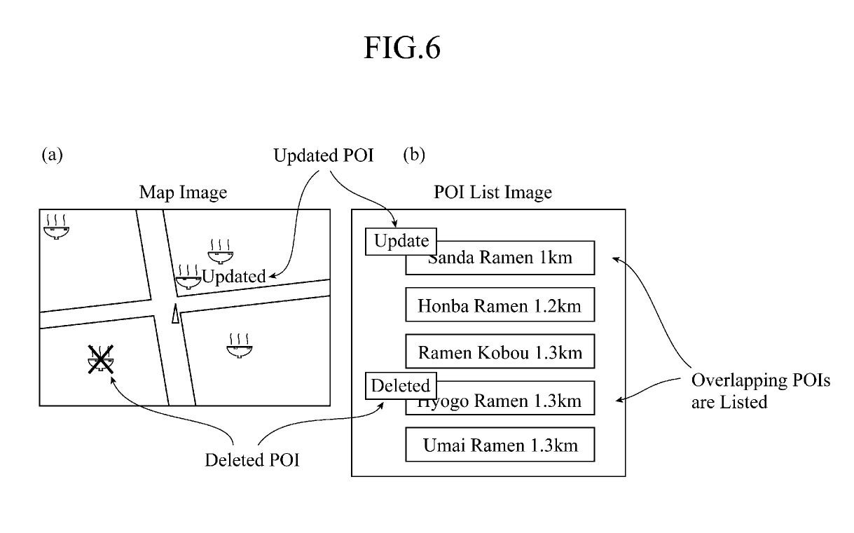

The display image generation unit 16 generates images to be displayed on the screen of the display unit 17 based on the list of the search result of the facility search unit 13 shown in FIG. 4 and the synthesized result of the facility information synthesis unit 15 shown in FIG. 5. The images generated by the display image generation unit 16 can be broadly classified into a map image as shown in FIG. 6(a), and a POI list image as shown in FIG. 6(b). The images generated by the display image generation unit 16 are sent as image data to the display unit 17.

Note that when the facilities indicated based on the facility information synthesized by the facility information synthesis unit 15 and the other facilities indicated based on the facility information not synthesized have an overlapping section, the display image generation unit 16 can be configured to generate images in which the antero-posterior relation of the display position is changed (for example, an image where the facilities indicated based on the synthesized facility information are disposed on top of the facilities indicated based on the facility information not synthesized). In other words, when the existing facilities stored in the facility information storage unit 11 are updated by the facility information stored in the additional information storage unit 12, the display image generation unit 16 may be configured to display the related POIs on top of the surrounding POIs. Moreover, the configuration may also be such that the POIs with a deletion flag of “1” are displayed behind the surrounding POIs. According to the configuration, the newly available POIs can be highlighted and presented to the user.

Moreover, the display image generation unit 16 can be configured to add to the facilities indicated based on the facility information synthesized by the facility information synthesis unit 15 a mark representing the effect to be highlighted. Specifically, as shown in FIG. 6, the display image generation unit 16 can be configured to add to the synthesized POI a mark representing the effect that has been updated to be highlighted, and also add a deleted mark to a POI in which the deletion flag is “1”. Moreover, the configuration may also be such that the POI itself is not displayed with respect to the POIs in which the deletion flag is “1”. Note that as the highlighting method, another method such as enlarging the POI, changing the color tone, or changing the brightness can also be used.

The display unit 17 is configured, for example, from an LCD (Liquid Crystal Display), and displays images based on the image data sent from the display image generation unit 16.

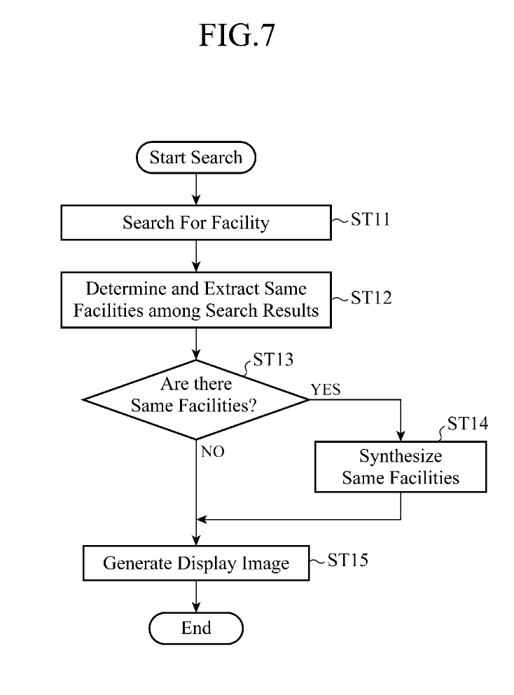

Next, the operation of the facility search device of Embodiment 1 in the invention configured as described above will be described mainly around the facility search processing with reference to the flowchart shown in FIG. 7.

When the facility search processing is started in response to the user's search request, the facility search is foremost performed (step ST11). Specifically, the facility search unit 13 searches both the facility information storage unit 11 and the additional information storage unit 12, and sends the search result to the sameness determination unit 14.

Subsequently, the same facilities among the search result are determined and extracted (step ST12). Specifically, the sameness determination unit 14 determines and extracts the facilities with the same identifier from the search result that is sent from the facility search unit 13.

Subsequently, whether the same facilities exist or not is checked (step ST13) . Specifically, the sameness determination unit 14 checks whether there are the same facilities or not among the facilities extracted in the step ST12. In the step ST13, when it is determined that the same facilities do not exist, the sequence proceeds to step ST15.

Meanwhile, in the step ST13, when it is determined that the same facilities exist, the same facilities are synthesized (step ST14). Specifically, when the sameness determination unit 14 determines that there are same facilities, it sends the facility information on the same facilities to the facility information synthesis unit 15, and the facility information synthesis unit 15 synthesizes the plurality of facilities that are determined to be the same POI in the sameness determination unit 14 into a single POI. Thereafter, the sequence proceeds to step ST15.

In the step ST15, the display image generation processing is executed. Specifically, the display image generation unit 16 generates images based on the facilities with no same facilities among the facilities obtained as the search result in the step ST11, and the facilities synthesized in the step ST14, and sends the resultant to the display unit 17 as image data. The display unit 17 displays images based on the image data that is sent from the display image generation unit 16. Thereafter, the facility search processing is ended.

As described above, according to the facility search device of Embodiment 1 in the invention, when both the facility information storage unit 11 and the additional information storage unit 12 are searched to display the facility information that is the search result, it is configured that the same facilities existing in the facility information storage unit 11 and the additional information storage unit 12 are synthesized and displayed based on the sameness determination; thus, it is possible to prevent the facilities from being displayed in an overlapping manner. Consequently, even in the case where there are overlapping facilities (POIs), they can be displayed in a manner that can be easily recognized by the user.

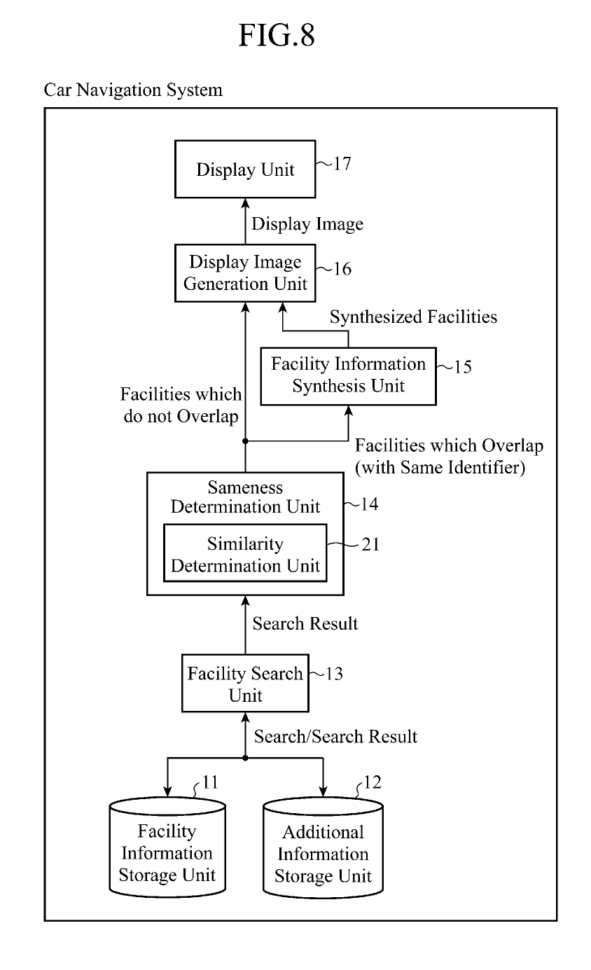

Note that the facility search device of Embodiment 1 discussed above can be modified as follows. Specifically, the sameness determination unit 14 can be configured to internally include a similarity determination unit 21 as shown in FIG. 8. The similarity determination unit 21 calculates the similarity based on information other than the identifiers contained in the facility information, for example, at least one among facility name, address, telephone number, coordinates and genre, and determines that the facilities are the same if the calculated similarity is not less than a certain value.

In the calculation of the similarity, the similarity of the facility name is obtained based on the degree of coincidence of character strings that is a well-known technique. The similarity of the address is obtained based on the degree of coincidence from the top of the character strings representing the address. The similarity of the telephone number is obtained based on the degree of coincidence of the numbers from the top. When the coordinate systems of the POIs are different from each other, for example, when there are POIs using the World Geodetic System and POIs using the Japanese Geodetic System, the similarity of the coordinates is obtained based on whether the distance is within a predetermined range or not. With respect to the genre, provided that the POI genre stored in the facility information storage unit 11 and the additional POI genre stored in the additional information storage unit 12 coincide with each other, if this is within the specification, the similarly thereof is obtained

According to a facility search device of a modified example of Embodiment 1, even in the cases where the map/facility information database to be used is different and the sameness cannot be determined based on the identifiers or the like, the sameness of the facilities can be determined from basic information on the facilities such as the coordinates or address, thereby preventing the same facilities from being displayed in an overlapping manner.

Moreover, a variety of methods can be used for the determination of the sameness in the sameness determination unit 14. For example, it can be configured as follows: the similarity of various attributes such as address and facility name is determined and, if the total value thereof is greater than a certain value, the facilities are determined to be the same POI.

Similarly, a variety of methods can be used for the integration of the search results in the facility search unit 13. For example, it can be configured such that the search results are integrated by using a union (integration) that is the fundamental operation of a database.

### Embodiment 2

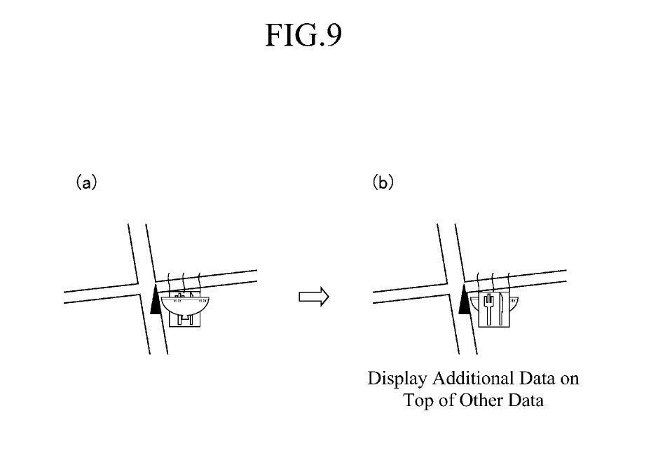

If identifiers cannot be used for determining the sameness of POIs, there is a possibility that the POIs which should be fundamentally the same are erroneously determined different POIs. For example, if a POI registered as a ramen shop in the existing database of a car navigation system is registered in the additional database as a restaurant for reasons of the renovation of the shop or the change in the menu, facility genres thereof are different from each other; thus, there is a possibility that the sameness determination unit 14 determines the same POI as different POIs. In this case, if the same POI are displayed as the different POIs, as shown in FIG. 9(a), the marks of two POIs are displayed in an overlapping manner, which makes it hard to convey the latest information (that the POI is a restaurant) to the user.

In order to avoid the foregoing situation, in a facility search device of Embodiment 2, as shown in FIG. 9(b), the POI registered as a restaurant is displayed on the front (on top) of the POI registered as a ramen shop, in order to preferentially present the latest information to the user. Moreover, when the POI is highlighted in addition to the displaying on the front, the new information is presented to the user with emphasis.

The configuration of the facility search device of Embodiment 2 is the same as the configuration of the facility search device of Embodiment 1 shown in FIG. 1.

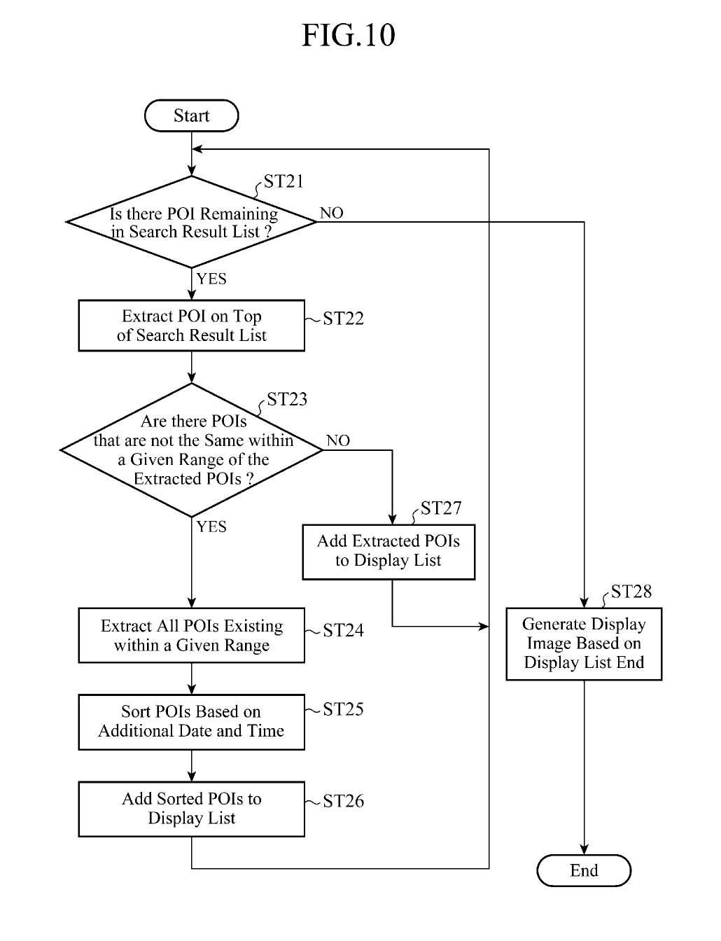

Next, the operation of the facility search device of Embodiment 2 of the invention will be described. The operation of the facility search device of Embodiment 2 is realized by substituting the display image generation processing of the step ST15 of the flowchart in FIG. 7 showing the operation of the facility search device of Embodiment 1 with the processing of the flowchart shown in FIG. 10. In the following, the sections different from the operation of the facility search device of Embodiment 1 are mainly explained. Note that the processing shown in the flowchart of FIG. 10 is executed by the display image generation unit 16. Moreover, let it be assumed that the POIs (including synthesized POIs) of the search result are sorted in order of distance and then stored in the search result list. In addition, the display list is a list which stores the order of displaying the POIs, and let it be assumed that the display list is empty at the start of the processing.

When the display image generation processing is started, foremost, whether any POIs remain in the search result list or not is checked (step ST21). In the step ST21, when it is determined that some POIs remains in the search result list, the uppermost POI of the search result list is subsequently extracted (step ST22). Specifically, the POI closest to the present location is extracted.

Subsequently, whether there exists a POI that is not the same within a given range of the extracted POI or not is checked (step ST23). Specifically, whether there exists a POI that is not the same within a given range of the extracted POI in the step ST22 is checked by confirming the coordinates of the POI. Here, for the given range, in consideration of the error that may arise due to the difference in the information source providing the POI information, or the error arising due to the datum converter, the range of these errors can be set as the given range.

In the step ST23, when it is determined that there exists a POI that is not the same within the given range of the extracted POI, all the POIs existing within the given range are subsequently extracted. Specifically, all the POIs existing within the given range from the POI extracted in the step ST22 are extracted from the search result list.

Subsequently, the POIs are sorted based on the additional date and time (step ST25) . Specifically, the POIs extracted in the step ST22 and the POIs extracted in the step ST24 are sorted in order of the additional date and time.

Subsequently, the sorted POIs are added to the display list (step ST26). Specifically, the POIs sorted in the step ST25 are added to the end of the display list with the order retained. Thereafter, the sequence returns to the step ST21, and the foregoing processing is repeatedly executed.

In the step ST23, when it is determined that the POI that is not the same within the given range of the extracted POI is absent, the extracted POIs are subsequently added to the display list (step ST27). Specifically, the POIs extracted in the step ST22 are added to the end of the display list. The sequence thereafter returns to step ST21, and the foregoing processing is repeatedly executed.

In the step ST21, if it is determined that no POI remains in the search result list, display images are subsequently generated based on the display list (step ST28). In this case, the order of the POI mark to be displayed on the map screen is generated, following the order of the display list, such that the front POI of the display list is displayed on the forefront of the screen. Thereafter, the display image generation processing is ended.

As discussed above, according to the facility search device of Embodiment 2 in the invention, even when the fundamentally same facilities are determined to be different facilities in the sameness determination, the facilities based on new facility information are displayed on the front; thus, the overlapping facilities can be displayed in an easy-to-understand manner.

Note that the display image generation unit 16 can also be configured to add a mark representing an update to the additional POI (facility) displayed on the front to be highlighted. As the highlighting method, at least one method among adding a mark to the additional POI (facility) displayed on the front, changing the size of the characters, changing the color tone, and changing the brightness can be used. According to the above configuration, since the new facilities are highlighted, the overlapping facilities can be displayed in an easy-to-understand manner.

### Embodiment 3

A facility search device of Embodiment 3 in the invention enables additional facility information to be acquired from outside the car navigation system.

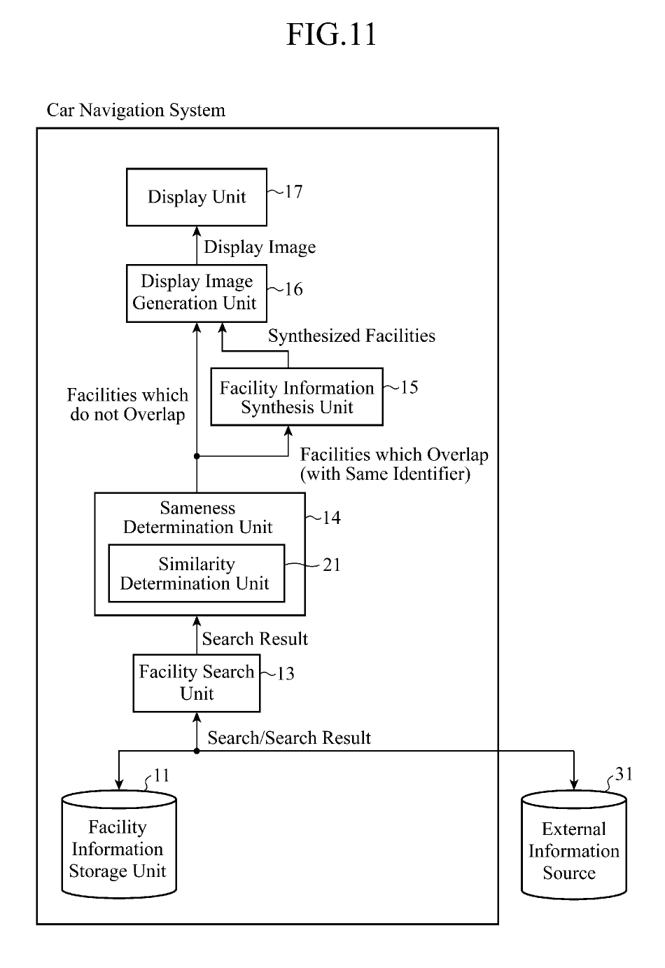

FIG. 11 is a block diagram showing the configuration of the facility search device of Embodiment 3. This facility search device is realized by removing the additional information storage unit 12 from the facility search device of Embodiment 1 shown in FIG. 1, and enabling the additional POI to be directly acquired from an external information source 31. As the external information source 31, a mobile phone carried in the vehicle or a server that is connected to a network such as the Internet may be used.

In the configuration, the facility search unit 13 searches for facilities from both the facility information storage unit 11 and the external information source 31, and integrates the results obtained from the search. When searching for facilities from the external information source 31, the facility search unit 13 sends a facility information acquisition request, together with the search conditions including the designation of an area, to the external information source 31. Consequently, additional facility information which may have a format that does not completely coincide with the facility information stored in the facility information storage unit 11 is obtained from the external information source 31. Note that in FIG. 11, the facility search unit 13 shows a configuration of acquiring the additional facility information from one external information source 31, but it may also be configured so that the additional facility information is acquired from a plurality of external information sources.

The operation of the facility search device of Embodiment 3 is the same as the facility search processing of the facility search device of Embodiment 1 shown in the flowchart of FIG. 7 excluding the point that the facility search unit 13 searches for the POIs from both the facility information storage unit 11 and the external information source 31.

As discussed above, according to the facility search device of Embodiment 3 in the invention, facility information stored in an external information source; for example, terminal equipment such as a mobile phone carried in the vehicle, or facility information stored in a server configuring an information gathering site on the Internet can be used for the facility search.

### Embodiment 4

A facility search device of Embodiment 4 in the invention enables the POI and the additional POI to be stored in a single information storage unit.

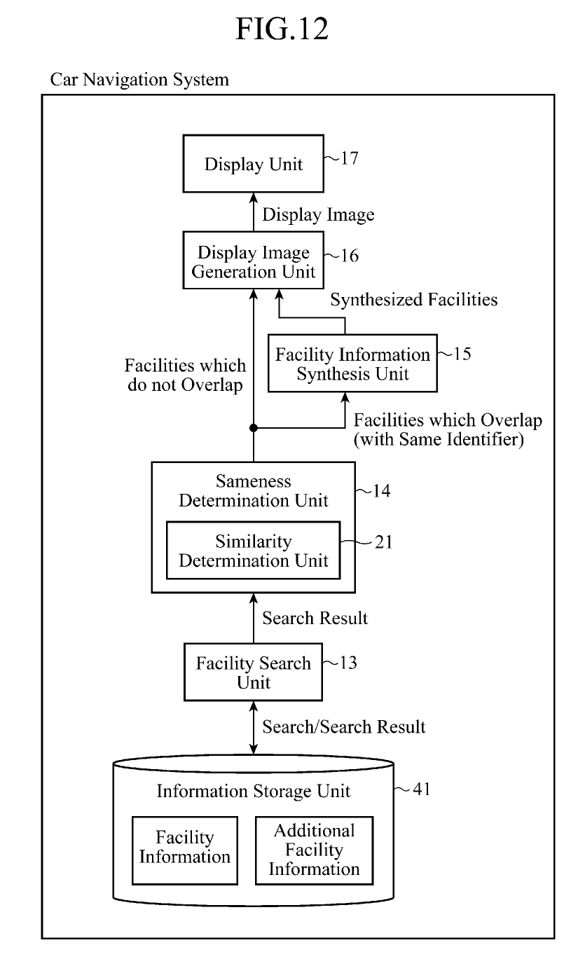

FIG. 12 is a block diagram showing the configuration of the facility search device of Embodiment 4. In the facility search device, the facility information storage unit 11 and the additional information storage unit 12 of the facility search device of Embodiment 1 shown in FIG. 1 are shared to be configured as a single information storage unit 41. The information storage unit 41 stores the facility information stored in the facility information storage unit 11 in the facility search device of Embodiment 1 and the additional facility information stored in the additional facility information.

The operation of the facility search device of Embodiment 4 is the same as the facility search processing of the facility search device of Embodiment 1 shown in the flowchart of FIG. 7 excluding the process that the facility search unit 13 searches for the POIs from the information storage unit 41.

As discussed above, according to the facility search device of Embodiment 4 in the invention, even in cases where the facility information on the fundamentally same facilities is stored redundantly in a single information storage unit, it is possible to prevent the same facilities from being displayed in an overlapping manner.

Moreover, since the facility information and the additional facility information are configured to be collectively stored in a single information storage unit, the size of the storage area can be reduced though the structure of the information storage unit may be complicated.

### Embodiment 5

A facility search device of Embodiment 5 in the invention stores the determination result of the sameness of facilities and the synthesized result of the facility information, and uses these in the subsequent processing.

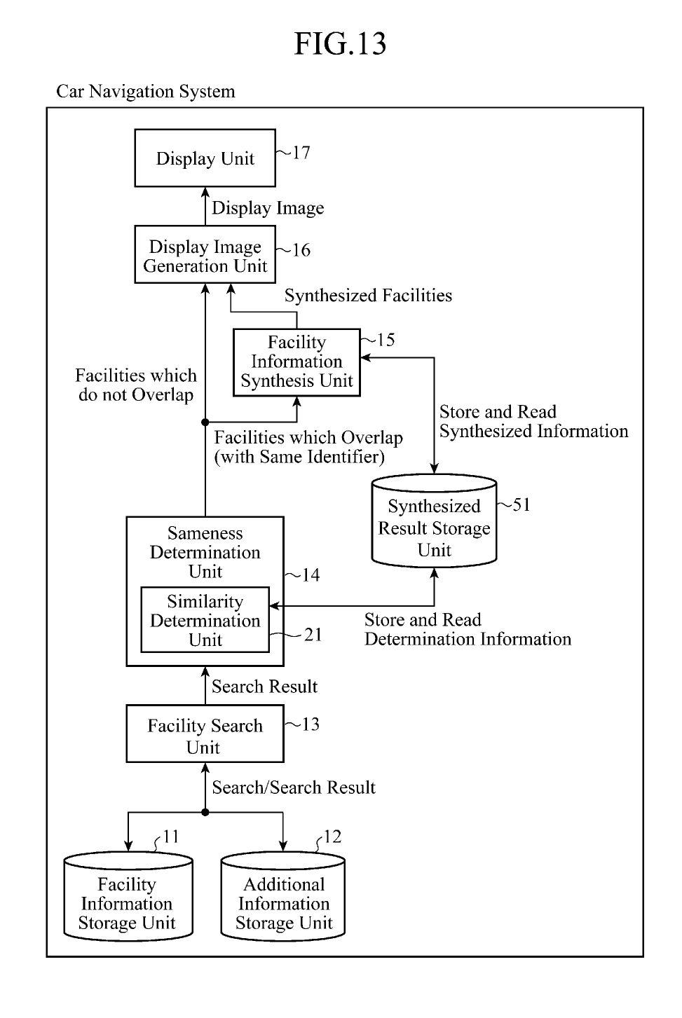

FIG. 13 is a block diagram showing the configuration of the facility search device of Embodiment 5. This facility search device is configured by adding a synthesized result storage unit 51 to the facility search device of Embodiment 1 shown in FIG. 1. The synthesized result storage unit 51 stores the determination result of the sameness determination unit 14 and the synthesized result of the facility information synthesis unit 15.

When the same search is conducted once again, the sameness determination unit 14 uses the determination result stored in the synthesized result storage unit 51 for determining the sameness of the plurality of facilities searched for by the facility search unit 13, and the facility information synthesis unit 15 uses the synthesized result stored in the synthesized result storage unit 51 for synthesizing the facility information on the facilities that are determined the same by the sameness determination unit 14.

As discussed above, according to the facility search device of Embodiment 5 in the invention, the time required for the processing can be shortened by using the determination result of the sameness determination unit and/or the synthesized result of the facility information synthesis unit in the past searches.

### INDUSTRIAL APPLICABILITY

The present invention can be applied to car navigation systems, mobile phones, PDAs (Personal Digital Assistants) and personal computers provided with a facility search function.

1. A facility search device, comprising:
a facility information storage unit that stores facility information that is information relating to facilities;
an additional information storage unit that stores additional facility information;
a facility search unit that searches for facilities from the facility information stored in the facility information storage unit and the additional facility information stored in the additional information storage unit;
a sameness determination unit that determines the sameness of facilities based on identifiers contained in the facility information on each of the facilities when the plurality of facilities are searched for by the facility search unit;
a facility information synthesis unit that synthesizes the facility information on the facilities determined to be the same by the sameness determination unit among the facilities searched for by the facility search unit;
a display image generation unit that generates images for displaying the facilities searched for by the facility search unit or the facilities synthesized by the facility information synthesis unit; and
a display unit that displays the images generated by the display image generation unit.

2. The facility search device according to claim 1, wherein the sameness determination unit has a similarity determination unit that calculates the similarity of each of the facilities from information other than the identifiers contained in the facility information, and determines the facilities to be the same when the calculated similarity exhibits not less than a certain value.

3. The facility search device according to claim 2, wherein the similarity determination unit calculates the similarity based on at least one of facility name, address, telephone number, coordinates and genre.

4. The facility search device according to claim 1, wherein when the facilities indicated on the basis of the facility information synthesized by the facility information synthesis unit and other facilities indicated on the basis of facility information not synthesized constitute an overlapping portion, the display image generation unit generates an image in which an antero-posterior relation is changed.

5. The facility search device according to claim 1, wherein the display image generation unit highlights the facilities indicated on the basis of the facility information synthesized by the facility information synthesis unit.

6. The facility search device according to claim 5, wherein the display image generation unit performs the highlighting on the basis of at least one of affixation of a mark, change of character size, change of color tone, and change of brightness to the facilities indicated on the basis of the facility information synthesized by the facility information synthesis unit.

7. The facility search device according to claim 1, wherein when facilities that are determined to be different facilities by the sameness determination exist within a predetermined range, the display image generation unit displays the facilities based on the facility information, in which the additional data and time added to the additional information storage unit are new, on the front of the facilities based on old facility information.

8. The facility search device according to claim 7, wherein the display image generation unit highlights the facility to be displayed on the front.

9. The facility search device according to claim 1, wherein the facility search unit searches for the facilities from the facility information stored in the facility information storage unit and additional facility information retained in an external information source.

10. The facility search device according to claim 9, wherein the external information source retaining the additional facility information is a mobile phone.

11. The facility search device according to claim 9, wherein the external information source retaining the additional facility information is a server connected via a network.

12. The facility search device according to claim 1, wherein the facility information storage unit storing the facility information and the additional information storage unit storing the additional facility information are configured from a single information storage unit, and
the facility search unit searches for the facilities from the facility information and the additional facility information stored in the information storage unit.

13. The facility search device according to claim 1, further comprising a synthesized result storage unit that stores the determination result of the sameness determination unit and the synthesized result of the facility information synthesis unit, wherein
the sameness determination unit uses the determination result stored in the synthesized result storage unit that determines the sameness of the plurality of facilities searched for by the facility search unit, and
the facility information synthesis unit uses the synthesized result stored in the synthesized result storage unit that synthesizes the facility information on the facilities determined to be the same by the sameness determination unit.
